(19) United States
(12) Patent Application Publication
(10) Pub. No.: US 2023/0174190 A1
(43) Pub. Date: Jun. 8, 2023

(54) CARGO TRAILER FOR A SCOOTER

(71) Applicant: Scott Derek Haynes, Main Beach (AU)

(72) Inventor: Scott Derek Haynes, Main Beach (AU)

(21) Appl. No.: 17/541,715

(22) Filed: Dec. 3, 2021

(51) Int. Cl. B62K 27/00; B62K 27/12

(52) U.S. Cl. CPC B62K 27/003; B62K 27/12

(57) ABSTRACT

A trailer is adapted to be mounted to a scooter for movement over a ground surface, the trailer having a trailer frame, a pair of wheels operably mounted on the trailer frame for rollably supporting the trailer frame on the ground surface, and a connector arm that extends from a proximal end that is attached to the trailer frame, to a distal end that is forward of the trailer frame. The connector arm extends upwardly from the trailer frame, but at no point does the connector arm extend beyond 550 mm above the ground surface. A hitching mechanism is attached to the distal end of the connector arm, the hitching mechanism being adapted to be removably attached to the scooter.

### BACKGROUND OF THE INVENTION

### Field of the Invention

This invention relates generally to trailers, and more particularly to a trailer that is adapted for use with a scooter.

### Description of Related Art

Trailers are commonly attached to bicycles, so that a bicyclist is able to carry cargo while on long rides. An example of this is shown in Hendon, U.S. Pat. No. 4,371,184, which teaches a frame mounted on a pair of wheels for supporting a cargo compartment. The cargo compartment is attached to the bicycle via a connector arm that extends upwardly at least 590 mm above the ground surface, so that it is able to clear a rear wheel of a bicycle, which is at least 584 mm. Since most bicycles have significantly larger wheels, a typical trailer is going to require a tubular arm that is at least 625 mm.

The prior art does not teach a trailer that has a connector arm that is adapted for use with a scooter, i.e., which extends upwardly less than 550 mm. The present invention fulfills these needs and provides further advantages as described in the following summary.

### SUMMARY OF THE INVENTION

The present invention teaches certain benefits in construction and use which give rise to the objectives described below.

The present invention provides a trailer that is adapted to be mounted to a seat post of a scooter for movement over a ground surface. The trailer comprises a trailer frame, a pair of wheels operably mounted on the trailer frame for rollably supporting the trailer frame on the ground surface, and a connector arm that extends from a proximal end that is attached to the trailer frame, to a distal end that is forward of the trailer frame. The connector arm extends upwardly from the trailer frame, but at no point does the connector arm extend beyond 550 mm above the ground surface. A hitching mechanism is attached to the distal end of the connector arm, the hitching mechanism being adapted to be removably attached to the seat post of the scooter.

A primary objective of the present invention is to provide a trailer having advantages not taught by the prior art.

Another objective is to provide a trailer adapted to attach to a scooter.

A further objective is to provide a trailer that includes a connector arm that extends from the trailer frame a maximum of 550 mm above a ground surface.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of one embodiment of a trailer that is adapted to be mounted on a scooter;

FIG. 2 is a side elevation view of the trailer of FIG. 1; and

FIG. 3 is a side elevation view of a second embodiment of the trailer.

### DETAILED DESCRIPTION OF THE INVENTION

The above-described drawing figures illustrate the invention, a trailer that is adapted to be mounted on a scooter.

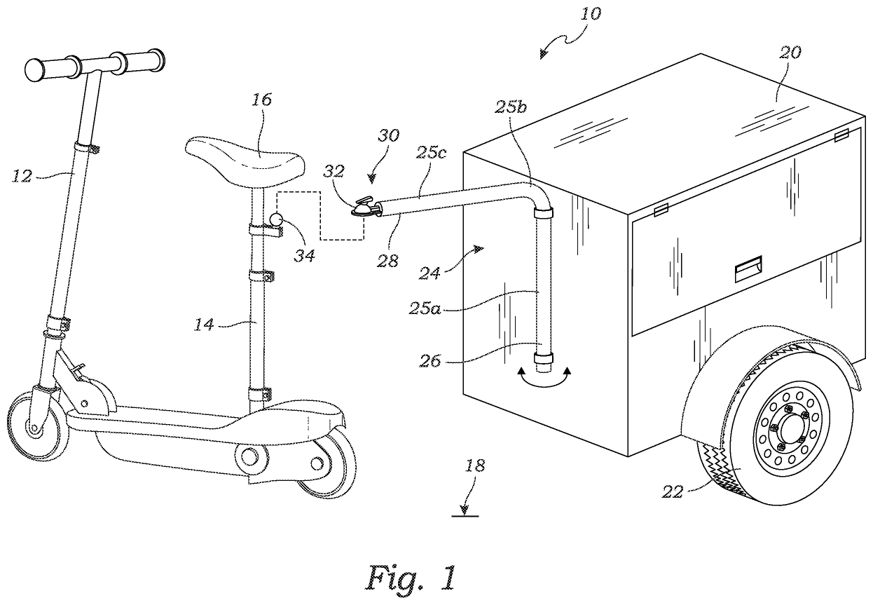

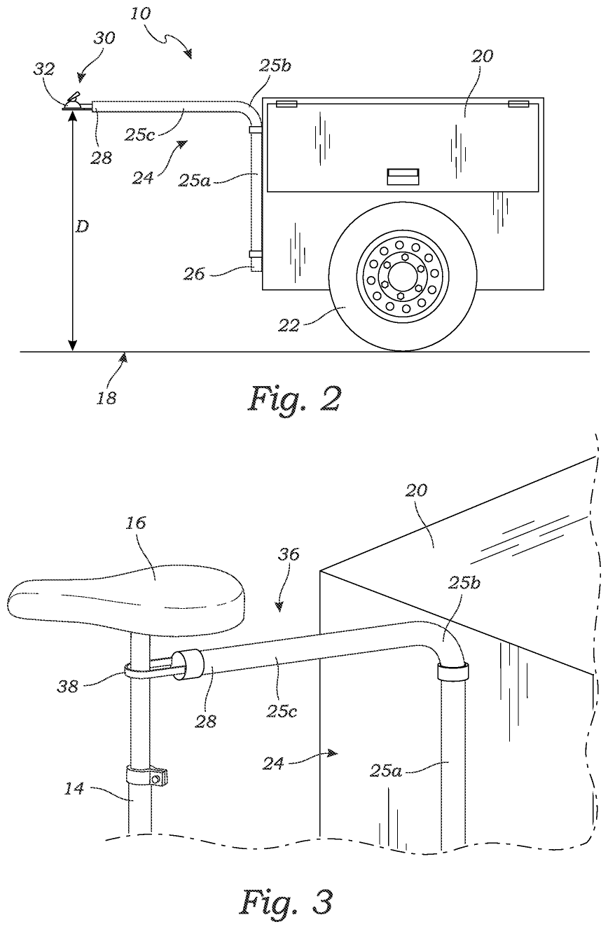

FIG. 1 is a perspective view of one embodiment of a trailer 10 mounted on a scooter 12. FIG. 2 is a side elevation view of the trailer 10 of FIG. 1. As shown in FIGS. 1-2, the trailer 10 is adapted to be mounted to the scooter 12 (e.g., by a seat post 14) for movement over a ground surface 18. The trailer 10 comprises a trailer frame 20, a pair of wheels 22 operably mounted on the trailer frame 20 for rollably supporting the trailer frame 20 on the ground surface 18, and a connector arm 24 that extends from the trailer frame 20 to a hitching mechanism 30, each component discussed in detail below.

In various embodiments, the trailer 10 may be provided in a wide range of dimensions and sizes, and may be constructed of any materials suitable for transporting a person's cargo via the scooter 12, which obviously may vary greatly depending on the type of scooter and the desired cargo. For the purposes of this application, “scooter” is defined to include any type of scooter, including push scooters, motor scooters, disability scooters, and electric scooters, or any other type of scooter, provided it has small rear wheels (e.g., at least 20% smaller than bicycle wheels on adult bicycles, which are 26 inches). In various implementations of the present invention, the scooter 12 may further include two wheels, three wheels, or more, which may be any type or size of wheels desired by the manufacturer.

While one example is shown in FIG. 1, the wheels 22 of the trailer 10 may be any diameter or thickness suitable for the size of the trailer frame 20, as well as various terrain the scooter 12 might encounter. In some embodiments, the pair of wheels 22 may be supported on the axle such that the trailer frame 20 is a greater or lower distance from the ground surface 18, or there may be an adjustment mechanism (not shown) for adjusting the distance. The pair of wheels 22 may include additional details such as tire treads, or a mechanism for removing and replacing the wheels 22, or any other features known to those in the art.

As shown in FIGS. 1-2, the trailer frame 20 may be any structure which may be used to store anything the user might want to tow. In one embodiment, the trailer frame 20 may be in the form of a cargo carrier, or a carrier for children, pets, etc. The trailer 10 further comprises the connector arm 24 that extends from a proximal end 26 that is attached to the trailer frame 20, to a distal end 28 that is forward of the trailer frame 20. The hitching mechanism 30 is attached to the distal end 28 of the connector arm 24, the hitching mechanism 30 being discussed in greater detail below. In the embodiment of FIGS. 1-2, the connector arm 24 has a vertical portion 25a that extends upwardly adjacent the trailer frame 20, and is connected with the trailer frame 20 at this place, currently with a pivot connector that allows rotation of the vertical portion 25a with respect to the trailer frame 20.

In this embodiment, the connector arm 24 further includes a curved middle portion 25b, and a horizontal portion 25c that extends away from the trailer frame 20 to the hitching mechanism 30. In this embodiment, the curved middle portion 25b bends approximately 90 degrees in a generally V-shape; however, alternative shapes may also be used, and should be considered within the scope of the present invention. Each portion 25 of the connector arm 24 may be integrally formed as a single piece, as shown, or alternatively, may be constructed separately and attached together. The vertical portion 25a may be attached to the trailer frame 20 via any functional means, e.g., via bolts, tiedowns, slidable or telescopic engagement, etc., or any other means known in the art. In this embodiment, the connector arm 24 is tubular in structure, having a generally cylindrical cross-sectional shape, but in other embodiments may be any desired structure, e.g., having a generally rectangular cross-section, or being in the form of a rigid rod, etc.

As shown in FIG. 2, in this embodiment, the horizontal portion 25c and hitching mechanism 30 are a distance D from the ground surface 18, which may be any height useful for connecting the trailer frame 20 with the scooter 12, so long as at no point does the connector arm 24 extend more than 550 mm above the ground surface 18. In this embodiment, D is approximately 440 mm or less above the ground surface 18.

The hitching mechanism 30 is adapted to be removably attached to the scooter 12. In the embodiment of FIGS. 1-2, the hitching mechanism 30 includes a socket 32 mounted on the distal end 28, at the end of the horizontal portion 25c, and further includes a ball 34 that is mounted on the scooter 12 (in this case, via the seat post 14) via a clamping mechanism (or any other attachment mechanism). In alternative embodiments, the ball may instead be attached to the connector arm 24 with the socket mounted on the seat post 14. Furthermore, in other embodiments, the hitching mechanism 30 may be any type of attachment, one example being shown in FIG. 3 and discussed below. The hitching mechanism 30 may alternatively be attached to other locations of the scooter 12, such as to a rear axle of the scooter, or other location.

FIG. 3 is a side elevation view of a second embodiment 36 of the hitching mechanism of the trailer 10. As shown in FIG. 3, in the second embodiment, the trailer 10 includes the alternative hitching mechanism 36 wherein a securing loop 18 is attached to the distal end 28 of the connector arm 24, which may be in the form of a flexible cord, a carabiner, retention hook, padlock, spring mechanism, etc., or any other similar securing loops, provided they are strong and secure enough to bear the weight of the trailer 10. The securing loop 38 may open to attach to the seat post 14, or it may be secured in any manner known in the art.

While first and second examples of the hitching mechanism are illustrated and described herein, other hitching mechanisms may be implemented within the scope of the present invention. For example, a compression lock, tubular telescopic engagement (i.e., wherein the seat is removed during installation), apertures formed in the seat post 14 and/or seat for engagement with hooks/bolts/etc., a twist lock, etc., or any other hitching mechanism known in the art that is compatible with the claims of the present invention.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular 100 embodiment, it is to be clearly understood that the invention is not limited to these embodiments, but rather the scope of the invention is defined by claims made to the invention.

What is claimed is:

1. A trailer that is adapted to be mounted to a scooter for movement over a ground surface, the trailer comprising:
a trailer frame;
a pair of wheels operably mounted on the trailer frame for rollably supporting the trailer frame on the ground surface;
a connector arm that extends from a proximal end that is attached to the trailer frame, to a distal end that is forward of the trailer frame, the connector arm extending upwardly from the trailer frame, but at no point does the connector arm extend more than 550 mm above the ground surface; and
a hitching mechanism attached to the distal end of the connector arm, the hitching mechanism being adapted to be removably attached to the scooter.

2. The trailer of claim 1, wherein the connector arm includes a vertical portion that is attached to the trailer frame, a curved middle portion, and a horizontal portion that extends to the hitching mechanism.

3. The trailer of claim 1, wherein the hitching mechanism includes a ball mounted on the distal end of the connector arm, and further includes a socket that is adapted to be mounted on a seat post of the scooter.

4. The trailer of claim 1, wherein at no point does the connector arm extend more than 440 mm above the ground surface.

5. A trailer that is adapted to be mounted to a seat post of a scooter for movement over a ground surface, the trailer comprising:
a trailer frame;
a pair of wheels operably mounted on the trailer frame for rollably supporting the trailer frame on the ground surface;
a connector arm that extends from a proximal end that is attached to the trailer frame, to a distal end that is forward of the trailer frame, the connector arm extending upwardly from the trailer frame, but at no point does the connector arm extend more than 550 mm above the ground surface; and
a hitching mechanism attached to the distal end of the connector arm, the hitching mechanism being adapted to be removably attached to the seat post of the scooter.

6. The trailer of claim 2, wherein the connector arm includes a vertical portion that is attached to the trailer frame, a curved middle portion, and a horizontal portion that extends to the hitching mechanism.

7. The trailer of claim 2, wherein the hitching mechanism includes a ball mounted on the distal end of the connector arm, and further includes a socket that is mounted on the seat post of the scooter.

8. The trailer of claim 2, wherein at no point does the connector arm extend more than 440 mm above the ground surface.
